(19) United States
(12) Patent Application Publication
(10) Pub. No.: US 2013/0095865 A1
(43) Pub. Date: Apr. 18, 2013

(54) CONTEXT-BASED MESSAGING

(71) Applicant: MARCOPOLOLOCO, LLC, White Hall, WV (US)

(72) Inventor: John Joseph Roets, White Hall, WV (US)

(73) Assignee: MARCOPOLOLOCO, LLC, White Hall, WV (US)

(21) Appl. No.: 13/653,864

(22) Filed: Oct. 17, 2012

Related U.S. Application Data
(60) Provisional application No. 61/548,033, filed on Oct. 17, 2011.

(51) Int. Cl. H04W 4/14

(52) U.S. Cl. 455/466

(57) ABSTRACT

Methods, computing devices, and computer-readable storage media for context-based messaging are disclosed. A computing device may receive a device location for mobile computing devices. The computing device may additionally accept messages for the mobile computing devices. The messages may comprise location information, time information, and recipient information. The time information may be configured as past, present, or future time. The messages may be transmitted to recipients identified in the recipient information responsive to the device location of a mobile computing device associated with the recipient corresponding to the location information and a device time of the mobile computing device associated with the recipient corresponding to the time information.

### CROSS-REFERENCE TO RELATED APPLICATION

This application claims priority under 35 U.S.C. §119(e) to U.S. Provisional Application No. 61/548,033, filed on Oct. 17, 2011, the contents of which are incorporated by reference in their entirety as if fully set forth herein.

### BACKGROUND

Communication services are one primary use of mobile computing devices, such as cellular phones, including smart phones, tablet computing devices, personal digital assistants (PDAs), and other devices having similar highly-mobile form factors. Accordingly, users rely on mobile computing devices to provide communication services, such as text messaging, email, telephone features, and data access and transfer. In general, the distribution and delivery of a mobile message is relegated to one or more user addresses or telephone numbers included in the message. For instance, a user may maintain contact groups (e.g., co-workers) on their mobile computing device to send a message to a specific set of recipients. However, there is generally no way of filtering recipients other than by specifying individual users or a group of users.

### SUMMARY

This disclosure is not limited to the particular systems, devices and methods described, as these may vary. The terminology used in the description is for the purpose of describing the particular versions or embodiments only, and is not intended to limit the scope.

In an embodiment, a computing device configured to manage context-based messages may comprise a wireless interface module, a processor operatively coupled to the wireless interface module and a non-transitory computer-readable storage medium operatively coupled to the processor. The non-transitory computer-readable storage medium may comprise one or more programming instructions that, when executed, cause the processor to: receive device location information associated with each of a plurality of mobile computing devices, accept a message received via the wireless interface module, the message comprising message location information and message time information, and transmit the message to a mobile computing device responsive to the device location information of the mobile computing device corresponding to the message location information and device time information of the mobile computing device corresponding to the message time information.

In one embodiment, a method for managing context-based messages may comprise receiving, at a computing device, device location information for each of a plurality of mobile computing devices. Messages may be accepted at the computing device for at least one of the plurality of mobile computing devices. The message may comprise message location information and message time information. The method may further comprise transmitting, via the computing device, the message to at least mobile computing device responsive to the device location information of the mobile computing device corresponding to the message location information and device time information of the mobile computing device corresponding to the message time information.

In one embodiment, a computer-readable storage medium may comprise instructions that, when executed, cause a system to receive device location information for each of a plurality of mobile computing devices and to accept a message for at least one of the plurality of mobile computing devices, the message comprising message location information and message time information. The instructions, when executed, may further cause a system to transmit the message to a mobile computing device responsive to the device location information of the mobile computing device corresponding to the message location information and device time information of the mobile computing device corresponding to the message time information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 depicts an illustrative data transfer network according to some embodiments.

FIG. 2 depicts illustrative internal hardware for a computing device according to some embodiments.

FIG. 3 depicts an illustrative graphical user interface (GUI) for context-based messaging according to some embodiments.

FIG. 4 depicts a flow diagram for an illustrative method for sending and receiving a context-based message according to some embodiments.

FIG. 5 depicts a flow diagram for an illustrative method for managing context-based messages according to some embodiments.

FIG. 6 depicts an illustrative spatial diagram comparing location information for a mobile message and a mobile computing device according to some embodiments.

FIG. 7A and FIG. 7B depict illustrative location and message information elements according to some embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

A “mobile computing device” refers to any portable computing device capable of connecting to a communications network for the purposes of transmitting and receiving data. Examples of mobile computing devices include, but are not limited to, notebook computers, tablet computers, personal digital assistants (PDAs), cellular telephones, smartphones (e.g., a cellular telephone with an integrated mobile operating system and associated hardware providing additional features beyond those of a standard cellular telephone), and other similar form factors.

A “mobile message” refers to any message sent to or received from a mobile computing device. Examples of mobile messages include, but are not limited to, emails, text messages (e.g., short messaging service (SMS) messages), voicemails, application messages (e.g., social network service messages or content publishing service messages), and other similar messages.

Consumers now rely on a mobile computing devices for communication, such as text messaging, email, telephone services (e.g., over the telephone network, through wireless communication over the Internet, etc.), data access and transfer, Internet access, and other similar functions. Consumers are also increasingly reliant on location capabilities of their mobile computing devices. For example, many mobile computing devices now include a global positioning satellite (GPS) receiver used by the mobile computing device to pinpoint its geographic location (fine grained location). Similarly, if the mobile computing device is configured to access a cellular network, the location of the mobile computing device may be approximated, for example, based on connection information associated with the mobile computing device, such as the location of cellular towers with which the mobile communication device has established a connection (coarse grained location).

Mobile messaging, through email, text messaging and other communication applications, has become an important communication tool for many people. However, distribution and delivery of a mobile message is relegated to limiting configuration functions, such as one or more user addresses or telephone numbers included in the message. A user may maintain specific recipient groups (e.g., co-workers, friends, family, and combinations thereof) on their mobile computing device to send a message to a specific set of recipients. However, there is generally no way of filtering recipients further than specifying individual users or groups of users.

Among other things, this disclosure is generally drawn to technologies including methods, computing devices, and computer-readable storage media for context-based messaging to one or more recipients based upon the location of each recipient at a defined time. For example, the system may comprise a plurality of mobile computing devices, each of which executes a context-based messaging software application specifically configured to interact with a server context-based messaging application hosted on a server computing device. The mobile context-based messaging application may determine the current location of the mobile computing device (e.g., through GPS information [fine location information], cellular network data [coarse location information] or some combination thereof), and may use the information locally or to update a server application with the location information. In an embodiment, a server computing device in communication with the mobile computing devices may maintain a record of mobile device information, including, without limitation time, location, user, message, mobile application information (e.g., state information and/or application data), and device information. In another embodiment, the mobile computing devices may each maintain a local record of their own respective information, such as location updates and/or other device information. In a further embodiment, the mobile computing devices may maintain a local record of their own respective location updates and the server may maintain a non-identifying (e.g., demographics only) record of location updates. In a still further embodiment, part of the device information may be stored locally on the mobile computing device and part of the device information may be stored on a remote server.

A message sent within the context-based messaging system between mobile computing devices may include message information, including, without limitation, recipient information (e.g., a recipient's address or telephone number), timing information and location information. For example, a user may send a message to a group of co-workers, setting the timing information for the current date and time and lasting through the next hour, and setting the location information to their office. The user may transmit the message to the server. Responsive to receiving the message, the server may store the message and then transmit the message to each of the recipients. Each of the recipients' mobile computing devices may receive the message and store the message in a local database. The mobile context-based messaging application for each recipient may check the timing information against the current time and the location information against the current location information for the mobile computing device.

If both the timing and location information match, or are within an acceptable range, the message may be delivered to the recipient. For example, the message may be presented on a mobile computing device display or delivered to an application inbox. If the timing information or the location information does not match, the message may be held in the database until the timing information expires. As the location of the mobile computing device changes, the mobile context-based messaging application may compare the updated location information against any messages stored in the local database. For any messages that match both timing information and location information, the messages are displayed. This enables a user to direct a message to a group of people based upon criteria other than the recipients' name, telephone number, or group, such as, for example, timing information and location information.

For instance, a manager may want to send a message to all employees at or close to the office, as well as to all employees who will be at or close to the office within the next hour. The manager may select a group of recipients (e.g., contact group “employees”), set the timing information to the present time through the next hour, set location information to the office, and include any pertinent text in the message. The manager may then send the message to each recipient. Each recipient may receive the message at their mobile computing device; however, delivery of the message may depend on the location of the recipient mobile computing device and the time. As such, the recipient may not be aware of the message unless they are at the specified location within the specified date and time range. If a recipient is at the specified location at the specified time, the message may be delivered to their mobile computing device, for example, for presentation on a mobile computing device display or for delivery to an email application inbox. Otherwise, the message may be stored, for instance, in a local database or a network database (e.g., corporate server database, Internet database, Internet Service Provider (ISP) database, or telecommunications network provider database) for all other employees (e.g., employees who are not at or close to the office) until either the timing information expires or the user satisfies the location information.

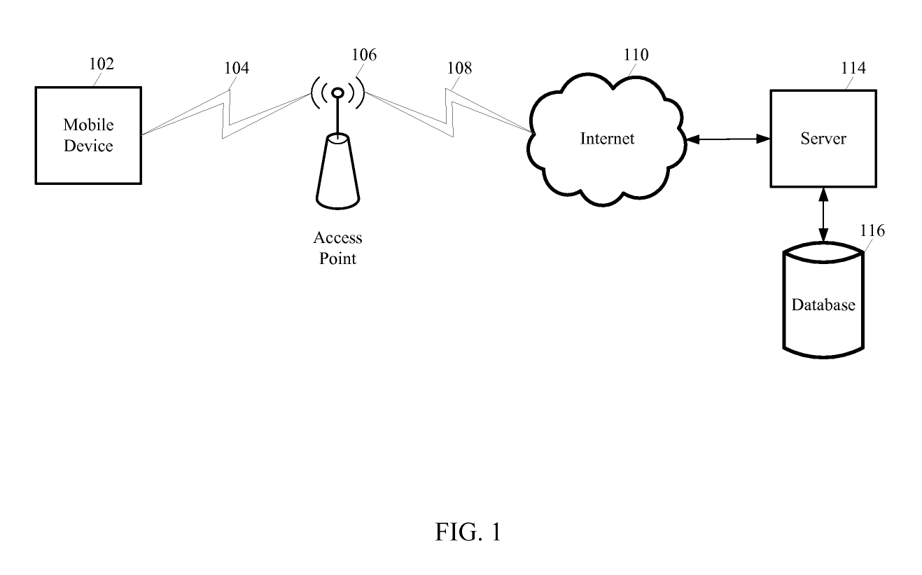

FIG. 1 depicts an illustrative network for transferring data between mobile computing devices according to some embodiments. An exemplary mobile computing device 102 may establish a wireless connection 104 to an access point 106. The type of wireless connection 104 may depend on the capabilities of the mobile computing device 102, the access point 106, or some combination thereof. For example, the mobile computing device 102 may establish a wireless network protocol (e.g., IEEE 802.11n) connection 104 to the access point 106 (e.g., a Wi-Fi hotspot). Alternatively, the mobile computing device 102 may establish a cellular data (e.g., 3^{rd} generation of mobile telecommunications technology (3G) or 4^{th} generation of mobile telecommunications technology (4G)) connection 104 to the access point 106 (e.g., a cellular tower). Additional and/or alternative connections may be established within the scope of this disclosure.

The access point 106 may be operably connected 108 to a wide area network (WAN), such as a corporate network or the Internet 110. A server 114 may be operably connected to the Internet 110 such that a connection may be established between the mobile computing device 102 and the server. The server 114 may be configured to receive messages from and send messages to the mobile computing device 102. The server 114 may be operably connected to a database 116 configured to store information related to the mobile computing device 102 and any other mobile computing devices operably connected to the server. For example, the server 114 may receive and store information related to the current geographical location of the mobile computing device 102.

Although one mobile computing device 102 is shown in FIG. 1 by way of illustration only, embodiments are not so limited, as multiple mobile computing devices may connect to the server 114 such that messages may be transferred from one mobile computing device to one or more other mobile computing devices. In addition, embodiments are not limited to the Internet 110 or an Internet-based network, as the depiction of the Internet in FIG. 1 is for illustrative purposes only. Any type of network capable of operating according to embodiments is contemplated herein, including private networks, peer-to-peer networks, local area networks (LANs), wide area networks (WANs), and cloud computing environments.

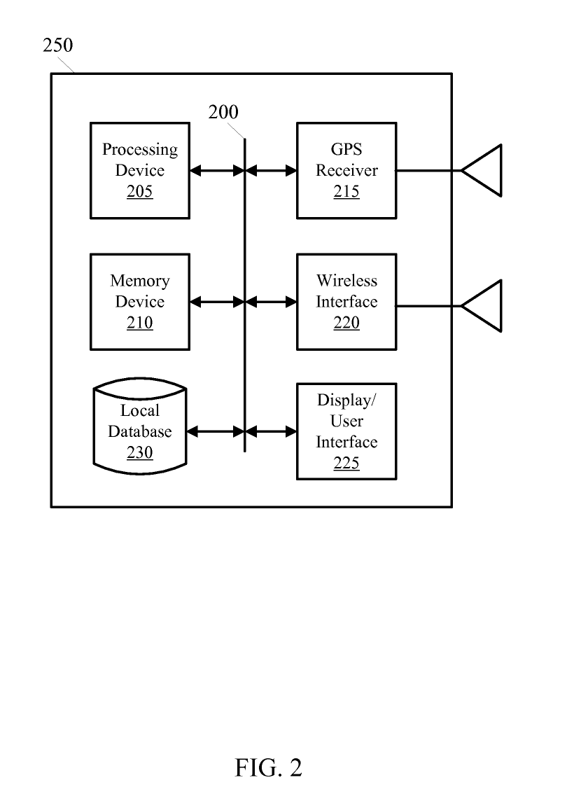

FIG. 2 depicts an illustrative block diagram of internal hardware that may be incorporated into a computing device 250 according to some embodiments. A bus 200 may serve as the main information interconnection between the other illustrated hardware components. A processing device 205 may be the central processing unit of the system, performing calculations and logic operations required to execute a program. The processing device 205 may interface with one or more optional memory devices 210 via the system bus 200. These memory devices 210 may include, without limitation, hard drives (e.g., stand-alone hard drives, RAID configurations, etc.), non-transitory computer-readable media, flash memories, SRAM, SDRAM, DRAM, or the like. Additionally, program instructions, software or interactive modules for performing any of the functional steps associated with the software applications (e.g., mobile and server context-based messaging applications) as discussed herein above may be stored in the memory devices 210. Optionally, the program instructions may be stored on a tangible computer-readable storage medium such as a flash memory, a memory card and/or other recording media accessible to the computing device 250.

The computing device 250 may further include a global positioning system (GPS) receiver 215 operably connected to an antenna. The GPS receiver 215 may be configured to receive signals from a global positioning satellite and transfer the received signals to the processing device 205. Based upon the signals, the processing device 205 may be able to determine a specific global location of the computing device 250. Embodiments are not limited to a GPS receiver, as any other type of device capable, at the present time or as developed in the future, of providing location information for the computing device 250 is contemplated herein, including, for example, the Galileo positioning system.

A wireless interface 220 may be used by the computing device 250 to establish a wireless data connection to a network. The wireless interface 220 may be configured to include multiple connection protocols. For example, the wireless interface 220 may be configured to establish a connection to a cellular data network such as a 3G or 4G network. Similarly, the wireless interface 220 may be configured to connect to a transfer protocol based network such as an IEEE 802.11n data network. Nonetheless, embodiments are not limited to wireless communication as the computing device 250 may use wired communication (e.g., Ethernet) devices and protocols according to some embodiments provided herein.

A display/user interface 225 may permit information from the bus 200 to be displayed on the display in audio, visual, graphic, or alphanumeric format. In an embodiment, the display/user interface 225 may include a touch-screen interface for receiving input from a user of the mobile computing device 102.

The computing device 250 may also include a local database 230 operably connected to the processing device 205 via the bus 200. The local database 230 may be configured to store information, including incoming and outgoing mobile messages until processed by the computing device 250 and/or historical location and time information associated with the computing device. For example the local database 230 may store the location and the time at the location as historical location and time information, such as: <location 1><time a>; <location 1><time b>, . . . , <location 2><time n>. In an embodiment, the computing device 250 may be in communication with a remote database configured to store the historical location and time information for the mobile computing device. In this embodiment, the location and time information may be transmitted to the remote database, for example, through the wireless interface 220.

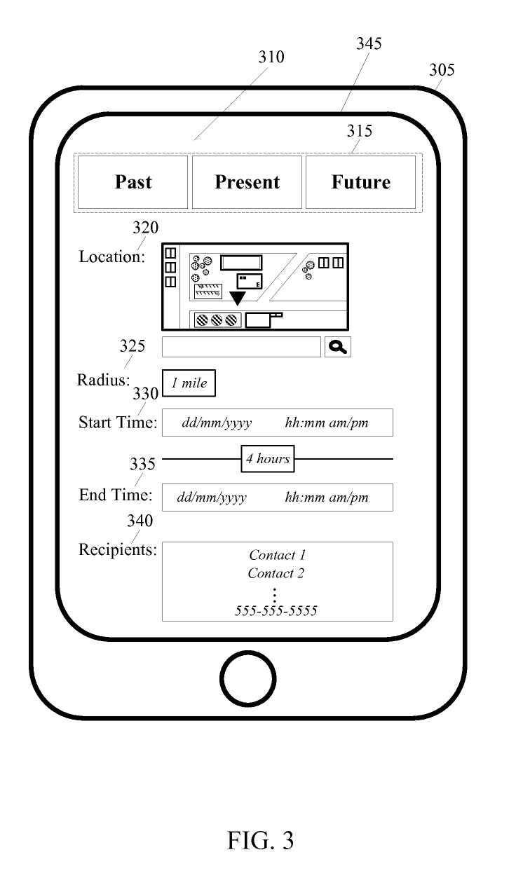

FIG. 3 depicts an illustrative graphical user interface (GUI) for context-based messaging according to some embodiments. In FIG. 3, a context-based messaging GUI 310 is presented on the display 345 of a mobile computing device 305. For example, the context-based messaging GUI 310 may be used to generate a context-based message. The context-based messaging GUI 310 may comprise a set of message time elements 315, including “Past,” “Present,” and “Future” elements. The message time elements 315 may operate, among other things, to specify whether the time information associated with the message relates to the past, the present, or the future.

A location selection element 320 may operate to select location information for the message, such as a geographic location (e.g., longitude and latitude coordinates or an address) or a specific location (e.g., a building, school, or stadium). According to some embodiments, the location selection element 320 may comprise functionality to enter location information via a map, a location search function, or some combination thereof. A radius element 325 may provide for entry of a radius associated with the location information. For example, a user may specify a particular location (e.g., a street address or a landmark) using the location selection element 320 and may further specify that the location information comprise an area specified by the radius element 325. A non-limiting example provides that a user may specify that the location information includes an area comprising a two-mile radius around a particular restaurant. Some embodiments provide that the radius may comprise various applicable units, including, but not limited to, miles, feet, yards, meters, kilometers, blocks, acres, buildings, natural (e.g., river) or man-made (e.g., cities, towns, counties, school campuses, etc.) boundaries, custom boundaries (e.g., user-generated and/or computer-generated boundaries created, for instance, through one or more software applications, such as the context-based messaging software application), and combinations thereof.

According to certain embodiments, a user may specify time information to be associated with the message. In this manner, a message may be configured to be associated with a specific location at a specific time. For example, the message may be configured to be associated with all recipients attending a function as identified by a specific location (e.g., a theater) at a specific time (the date and time range of the function). As shown in FIG. 3, a start time element 330 may allow a user to specify a start time to be associated with the time information of the message. In an embodiment, the start time may comprise a date and/or a time, for example, Jan. 1, 2013 at 12:00 a.m. An end time element 335 may be configured to specify an end time to be associated with the time information of the message. For example, a user may manually enter an end date and/or time or a user may select a duration to add to the start time (e.g., 4 hours, 24 hours, 1 week, etc.).

Message recipients may be selected via a recipient selection element 340. In an embodiment, recipients may be selected based on name, contact name, number, group, or combinations thereof. Some embodiments provide that the message may be sent to the recipients, and may be delivered if the mobile computing devices 305 associated with the recipients have location and time information corresponding to the location and time information specified for the message through the message time elements 315, location selection element 320, radius element 325, start time element 330, and/or end time element 335.

In an embodiment, recipients may be private and/or public. Private recipients may comprise recipients selected by the user, for example, from a contact list via the recipient selection element 340. Public recipients may comprise a group of unspecified recipients, such as all users associated with one or more service providers, users associated with a specific area code, computing device brand and/or operating system (e.g., Apple® iOS), users associated with a particular organization, the general public and combinations thereof. According to some embodiments, public messages may be delivered if the mobile computing devices 305 associated with the recipients have location and time information corresponding to the location and time information specified for the message through the message time elements 315, location selection element 320, radius element 325, start time element 330, and/or end time element 335.

Selection of a start time and an end time operates to specify an active duration for the message, depending on the selection of the message time elements 315. For example, if the user selects a “Past” message time element 315, then the time duration relates to a time in the past. An illustrative and non-restrictive example provides that a user may select a time duration of Mar. 1, 2012 at 7:00 p.m. to Mar. 1, 2012 at 10:00 p.m. and a location of Stadium A with a radius of 1 mile. In this example, the message may be sent to all selected recipients and the context-based messaging system will operate according to some embodiments provided herein to deliver the message only to the recipients that have historical location and time information that match or substantially match the specified message location and time information. As such, only recipients who were within about 1 mile of Stadium A between about Mar. 1, 2012 at 7:00 p.m. to about Mar. 1, 2012 at 10:00 p.m. may have the message delivered to their device.

The context-based messaging GUI 310 depicted in FIG. 3 provides one illustrative embodiment. Embodiments may contain more or fewer elements arranged in various configurations. In an embodiment, the context-based messaging GUI 310 may be arranged on multiple GUI screens including more or fewer elements than shown in FIG. 3. In another embodiment, the context-based messaging GUI 310 may include a GUI element for entering message text, a subject, attachments, and other message elements. Accordingly, the context-based messaging GUI 310 is not limited by the illustrative embodiment depicted in FIG. 3.

According to some embodiments, users may register with one or more services that provide context-based messaging. The one or more services providing context-based messaging may operate to collect demographic information pertaining to registered users, including, but not limited to, age, gender, educational level, interests (e.g., sports, products, media preferences), consumer preferences, and address information. According to some embodiments, the demographic information may be obtained by various processes. For instance, the demographic information may be obtained by a service provider from the computing device, such as through available information on the computing device or through an application installed on the computing device (e.g., a context-based messaging application, including a mobile application (or mobile “app”)). In another example, the demographic information may be obtained through information entered by a user in an application or website associated with a service provider, such as when a user registers with a context-based messaging service provider.

In an embodiment, context-based messages may be configured to include demographic information in addition to location and time information as criteria for sending a message to one or more recipients. A non-limiting example may provide that a context-based message may be tailored to users within a certain radius of a retailer at a certain time who are within a certain age range and have a certain set of interests (e.g., skiing, reading a certain genre of books, undergraduate degree, occupation, etc.).

According to some embodiments, the context-based messaging system may be configured to provide advertisements and other commercial messages (e.g., coupons, discounts, vouchers, marketing, etc.). For instance, a user may register with a retailer to providing context-based messaging to users located in one or more stores or within a certain vicinity of one or more stores. As such, a context-based message provider may generate messages according to embodiments described herein that are tailored to specific demographic information, patterns discernible from user location and time information, or combinations thereof. For instance, a context-based message may be set to be delivered only if a user has live music as an interest, is male, over twenty-one years of age, and has been in one or more specific locations in the past six months, at a particular location more than ten times in the past month, and appears at another location in the future.

In an illustrative and non-restrictive example, users may be registered with a news service or other organization, and the message may be seeking information from individuals who were at a baseball game at Stadium A at a specified time when a news event occurred. The news service may be seeking information from individuals likely to be at the baseball game.

Another illustrative and non-restrictive example provides that users planning on attending an event or students at a university may register their mobile communication devices with the context-based messaging service to receive messages if they are at a location at a future time. For instance, through the context-based messaging service, a university may send a message to students who are in a certain campus library at a certain time to remind them that the library will be closing early. In another example, users planning on attending a concert may register with a context-based messaging service to receive messages relevant to the concert (e.g., parking, merchandise, discounts, etc.) when they are at the concert venue.

In a further illustrative and non-restrictive example, users may register their mobile communication devices with the context-based messaging service to receive certain location and time based alerts, such as traffic alerts. For instance, registered users located on a certain route may receive a message regarding a traffic accident further along the route or registered users may receive a traffic information message at a predetermined time comprising rush hour traffic information so that they may choose their route home before they leave work.

A still further illustrative and non-restrictive example provides that the context-based messaging service may be associated with one or more social networks, such as Facebook® or LinkedIn®, wherein, recipients may be selected based on relationships established in a social network. For example, a user may send a message to recipients associated with a social network who will be located within a certain radius of a restaurant at a certain time in the future.

Embodiments are not limited to computing devices associated with users registered with one or more services or to private recipients, for example, listed in a mobile computing device contact list. For example, some embodiments provide that computing devices capable of receiving messages may receive context-based messages according to embodiments described herein as part of a public group. For example, a telecommunications service provider may send a message to computing devices (e.g., smart phones and other computing devices) on one or more network managed by the telecommunications service provider based on the location of the computing devices and the time. In another non-limiting example, a government entity, such as a local municipality, may send context-based messages to known computing devices in a specified area at a specified time. In this manner, the government entity may send alerts and/or other information, for instance, to users in an area experiencing or potentially experiencing a certain event (e.g., hurricane, terrorist attack or threat). As such, embodiments provide that messages may be sent to unspecified members of a public group.

According to some embodiments, messages may comprise various forms of information, including, without limitation, text, audio, images, video, data, and combinations thereof. In an embodiment, messages within the context-based messaging system may be configured as personal messages, with or without location and time information.

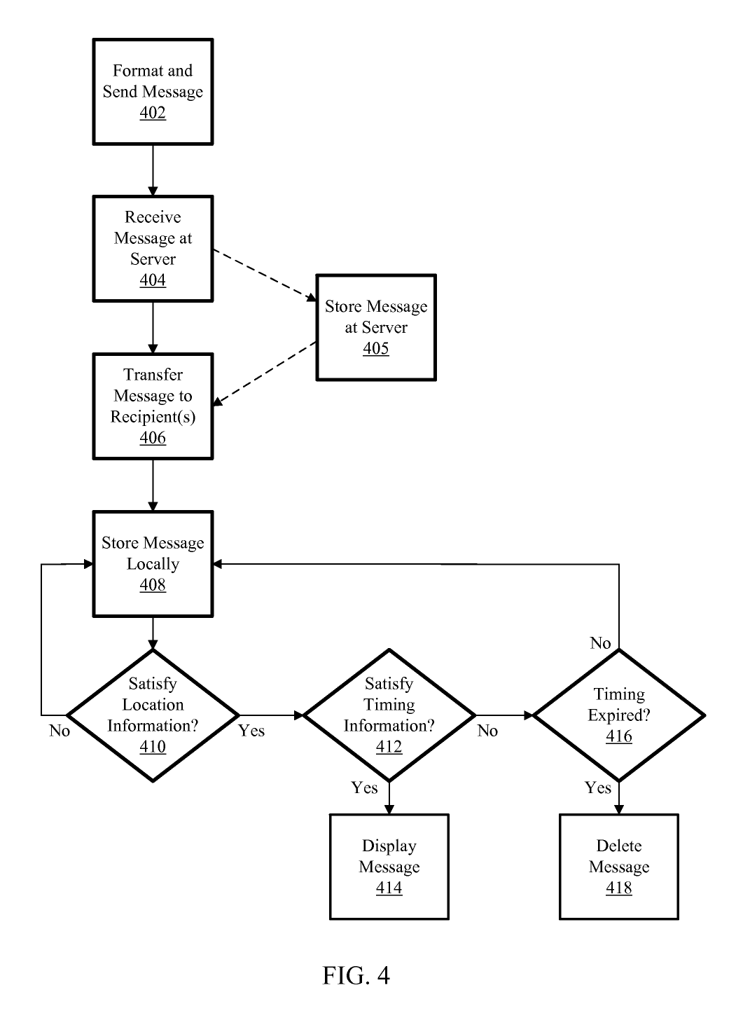

FIG. 4 depicts a flow diagram for an illustrative method for sending and receiving a context-based message according to some embodiments. The illustrative method of FIG. 4 may be performed, for example, by one or more computing devices 102, 114 depicted in FIG. 1 and/or computing device 250 depicted in FIG. 2, each described in more detail below. In addition, the illustrative method of FIG. 4 may include one or more operations, functions, or actions as illustrated by one or more of blocks 402, 404, 405, 406, 408, 410, 412, 414, 416, and/or 418. The operations described in blocks 402 through 418 may also be stored as computer-executable instructions in a computer-readable medium, such as the memory device 210 of the computing device 250 depicted in FIG. 2. Although illustrated as discrete ordered blocks, various blocks may be divided into additional blocks, combined into fewer blocks, or eliminated, removed, and re-ordered, depending on the desired implementation.

A user may format 402 and send a message to one or more recipients. The user may format 402 the message via the mobile context-based messaging application on the user's mobile computing device (e.g., mobile computing device 102). The message may include one or more recipients (e.g., a recipient group, some or all of the user's contacts, or a public group), a location (determined by a name such as “My Office,” coordinates on a map, or the like), a start time, an end time (or a duration of time), and message coverage (i.e., the radius out from the location within which the message will be delivered).

The message may be received 404 by a server (e.g., server 114) via a network or Internet connection. Depending on the timing data associated with the message, the server may store 405 this message, for example, in a database (e.g., database 116). The server may then transfer 406 the message to the one or more recipients. The server may transfer 406 the message to the recipients based upon their location in the interval between the start time and the end time. In this manner, a mobile computing device may only receive messages relevant to the location and time such that, for instance, the mobile computing device is not overloaded with data and/or messages. Depending on the organization and implementation of the mobile computing device, and any messaging applications associated therewith, the transfer 406 may be in response to a mobile application request for messages, a server push of all messages to the recipients according to a time schedule, or some combination thereof. Illustrative messaging applications may include, without limitation, email applications (e.g., Microsoft® Outlook®, or Gmail®), social network services (e.g., Facebook® or LinkedIn®), and content publishing services (e.g., Twitter® or Pinterest®).

Each recipient mobile computing device may receive the transferred 406 message and store 408 the message locally, for example, in a local database (e.g., database 230) or messaging application. The mobile context-based messaging application on the recipient's mobile computing device may determine 410 if the position of the mobile computing device satisfies the location information of the message. If the position of the mobile computing device does not satisfy the location information, the mobile context-based messaging application may store 410 the message until the location of the mobile computing device changes. If the position of the mobile computing device does satisfy the location information for the message, the mobile context-based messaging application may determine 412 whether the timing information is satisfied.

In an embodiment, the mobile context-based messaging application may determine whether the timing information is satisfied 412 before determining if the position of the mobile computing device satisfies the location information of the message 410. For example, some embodiments provide that it may be require fewer resources to determine a time associated with a device compared to determining the location associated with a device.

When sending 402 a message, a user may assign various timing information to the message such as a start time for delivery of the message, a duration of time for the message to last, or an end time specifying a message expiration time. This provides options for a user to send 402 a message now, send a message in the future, or send a message to the past.

When sending 402 a message now, the server receives 404 the message and transfers 406 the message to the recipient(s) at their next check in or via an immediate push to all recipient devices. When sending 402 a message in the future, the server may hold the message until a reasonable period of time before the message's start time. This may operate to reduce the amount of time the mobile context-based messaging application will need to store and manage the message. When sending 402 a message to the past, the server may query historical location and time information to determine which, if any, of the recipients' devices were at the location indicated in the message at the indicated time in the past and, if there are identified recipients, send the message to only those identified recipients.

Referring again to FIG. 4, the mobile context-based messaging application may determine 412 if the timing information is satisfied, for example, if the current time is within the allotted time period as defined by the timing information in the message. If the mobile context-based messaging application determines 412 the timing information is satisfied, the mobile context-based messaging application may display 414 the message to the user. Alternatively, if the mobile context-based messaging application determines 412 that the timing information is not satisfied, the mobile context-based messaging application may determine 416 if the timing information has expired. If the timing information has expired, the message may be deleted 418. Otherwise, the message may be maintained and checked again after a period of time.

The illustrative method depicted in FIG. 4 is shown by way of example only as an exemplary embodiment of transmitting a message through a network to one or more recipients based upon location and timing information contained within the message and the current location of the recipient(s). Certain parts of the illustrative method may be expanded, performed in a different order, or removed from the process, thereby resulting in an alternate process for achieving a similar result. For example, in one embodiment, the server may store all messages until the timing information is satisfied and only transfer the messages to mobile computing devices satisfying the location information of the message that check in (e.g., send message or pull requests) with the server while the timing information is satisfied. Thus, all determination and processing is removed from the mobile computing device to the server, reducing the processing requirements of the mobile computing device to merely receiving and displaying the message. In another embodiment, the server may send all messages to the recipient mobile computing devices and the context-based message processing may occur at the mobile computing device, for example, through the context-based messaging application.

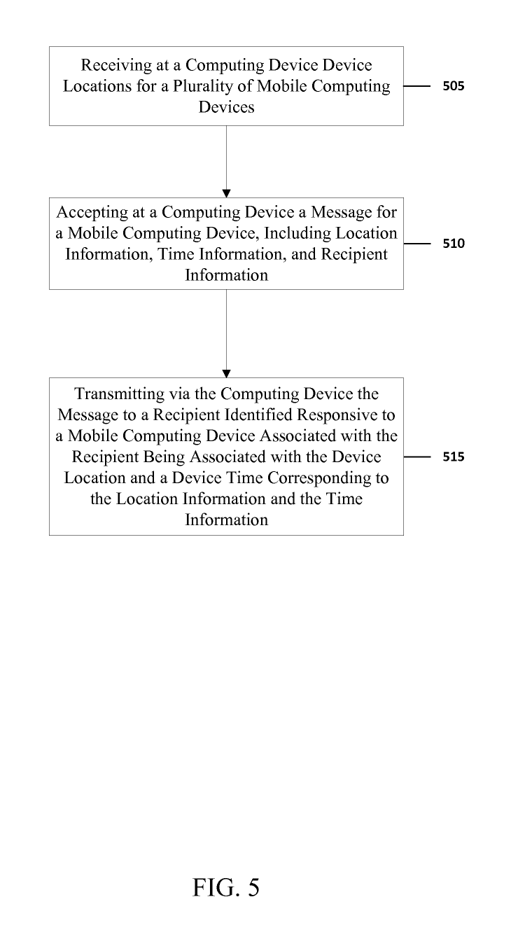

FIG. 5 depicts a flow diagram for an illustrative method for sending and receiving a context-based message according to some embodiments. A computing device may operate to receive device locations for a plurality of mobile computing devices 505. For example, the mobile computing devices may operate to determine their location, such as via GPS (fine position) or through communication system components (e.g., access points or cellular network towers) (coarse position). The mobile computing devices may make this information available to other computing devices, such as a server computing device or other mobile computing devices. In an embodiment, each of the plurality of mobile computing devices may periodically send their position information, along with other information, such as the local date and time, to a server computing device, for example, operating a server context-based messaging application. In another embodiment, a computing device, such as another mobile computing device, may poll for the location information of peer mobile computing devices, for example, operating a mobile context-based messaging application (e.g., in the form of a mobile application (mobile “app” or “app”) or an Internet-based application (web “app”)).

A computing device may accept a message addressed to a mobile computing device 510. For example, the computing device may store the message in a database, in an undelivered form in the context-based messaging application or other application (e.g., email application, social networking service or content publishing service), or a similar storage location. In an embodiment, the computing device may include a mobile computing device and the message may be addressed to the mobile computing device and stored locally.

The message may comprise location information, timing information, and recipient information 510. In an embodiment, the location information may comprise information indicative of a location (e.g., geographic area) where the message may be delivered, provided that one or more other conditions (e.g., timing and/or recipient conditions) are satisfied. Some embodiments provide that the timing information may comprise a time or a time range in the present or future wherein the message is targeted for delivery, provided that one or more other conditions (e.g., location and/or recipients) are satisfied. For example, the timing information may specify that the message may be delivered to recipients at a particular location during a time range spanning 5 to 10 hours into the future. In some other embodiments, the timing information may comprise a time or a time range in the past. For instance, past timing information may specify that a message may be delivered to recipients who were at a particular location during a time range in the past. According to some embodiments, the recipient information may comprise a collection of recipients intended to receive the message responsive to the location and timing conditions being satisfied.

The computing device may operate to transmit the message to a recipient responsive to a mobile computing device associated with the recipient being associated with a device location and a device time corresponding to the location information and the time information of the message 515. For example, the context-based messaging application may operate to determine whether a mobile computing device associated with a message recipient satisfies the location and timing conditions specified in the message. Responsive to a mobile computing device associated with a message recipient having a device location at a device time that matches the location information and the timing information of the message, the computing device may deliver the message.

In an embodiment, the device time may be based on a time perspective specified at the computing device, in the context-based messaging application, or at the mobile computing device. For example, the time perspective may be the local time at the mobile computing device (e.g., Eastern Standard Time), the time at the server, the local time at the computing device where the message is generated, a relative time (e.g., for the next 5 hours or 5 hours into the future), or combinations thereof.

In an embodiment, the time information associated with a computing device, such as a mobile computing device, may be determined using various time sources. Non-limiting examples of time sources include time functions resident on the computing device (e.g., in hardware and/or software), global positioning satellite systems, third-party time applications, service providers (e.g., Internet service providers and/or telecommunications service providers), and combinations thereof.

According to some embodiments, the device location and/or the device time may not necessarily match the location information and/or the timing information exactly. For instance, the context-based messaging application may be configured to allow for one or more outside ranges when comparing the device location and/or the device time to the location information and/or time information. For example, the context-based messaging application may be configured such that a device location within 1 mile of the area specified by the location information may be considered to be a match. In another example, the context-based messaging application may be configured such that a device time within 1 hour of the time range specified by the location information may be considered a match.

In another embodiment, the context-based messaging application may operate to inform the message creator (e.g., through a message or an alert) that a mobile computing device meets the conditions specified by the location information and the timing information, but is not associated with the recipient information. For example, the mobile computing device may be known to the message creator (through a mobile device), for example, because the mobile computing device is associated with a contact or a social network connection. In another example, the mobile computing device may be associated through a public group. In this embodiment, the context-based messaging application may alert the user and inquire as to whether the message creator may want to associate the mobile computing device to the recipient information. The message creator may elect to maintain the original recipient information or may update the recipient information to associate the mobile computing device located by the context-based messaging application. In this manner, the message creator may send the message to a recipient that was not included in the recipient information but matches the location information and the time information.

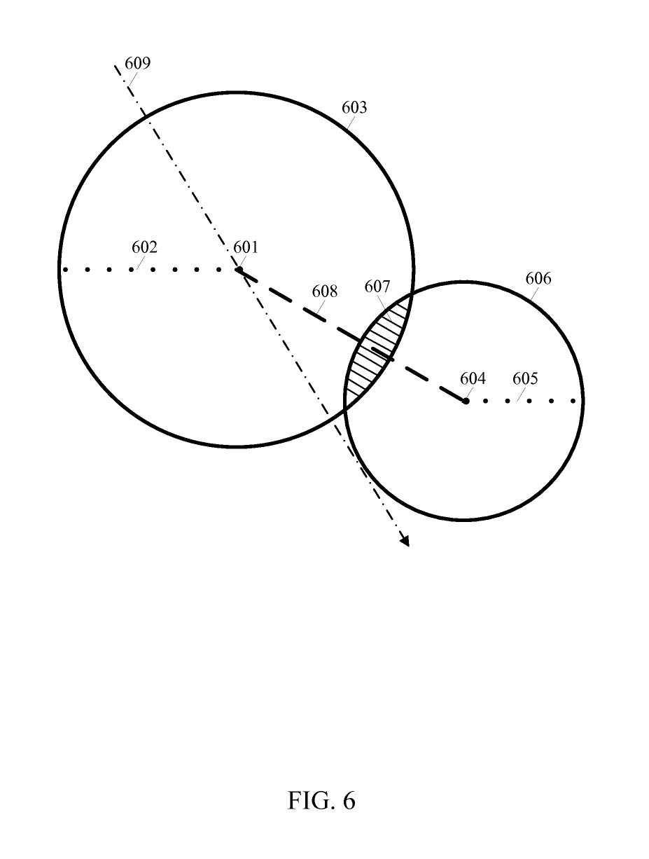

FIG. 6 illustrates an exemplary spatial diagram comparing a user's location and the location of a message intended for delivery to the user according to some embodiments. Specifically, an estimated location 601 of the mobile computing device (or user) is shown in relation to defined message location 604. The mobile computing device has a measured inaccuracy 602 related to its exact location as calculated by the mobile computing device's internal hardware (such as GPS receiver 215 and processing device 205 as shown in FIG. 2). The message has a defined coverage or radius 605 as determined by the sender of the message. A mobile computing device location area 603 may be the area centered on the mobile computing device location 601 and encompassed by the measured inaccuracy 602, thereby forming a circle around the mobile computing device having a radius equal to the measured inaccuracy.

Similarly, a message location area 606 is the area centered on the message location 604 and encompassed by the defined message coverage or radius 605, thereby forming a circle around the message location having a radius equal to the defined coverage of the message. The distance between device location area and message location area is given as 608. If the device location area 603 intersects, as shown in shaded region 607, with the message location area 606, then the message is said to be active or notifiable for this user/device. This intersection may occur as the device/user moves over time 609 toward the message location 604. This intersection may be calculated according to the following:

intersection=distance≦message radius+accuracy.

The illustrative embodiment depicted in FIG. 6 is shown by way of example only. In addition, the equation for determining the intersection of a mobile computing device and a message location is shown by way of example only and may be expanded, refined or revised accordingly based upon the implementation of the process and system.

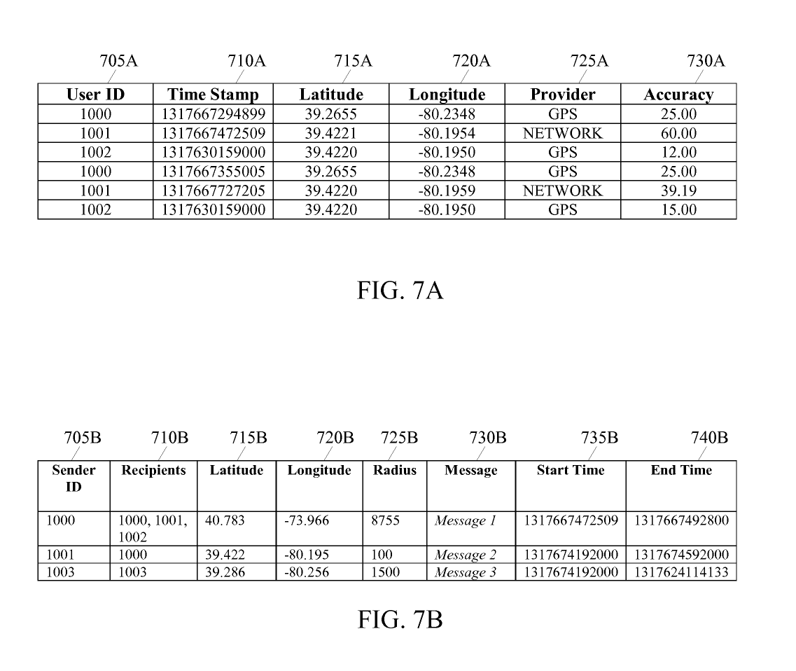

FIG. 7A and FIG. 7B depict illustrative timing and message information according to some embodiments. As shown in FIG. 7A, maintained location update data may comprise one or more of the following message information elements: user ID 705A, time stamp 710A, latitude 715A, longitude 720A, provider 725A, and accuracy 730A. As shown in FIG. 7B, maintained message data may comprise one or more of the following message information elements: Sender ID 705B, recipients 710B, latitude 715B, longitude 720B, radius 725B, message 730B, start time 735B, and end time 740B.

Embodiments are not limited to the information elements depicted in FIG. 7A and FIG. 7B, as these are illustrative and non-restrictive. More or fewer information elements may be maintained and/or used to generate and/or deliver messages according to embodiments described herein. In an embodiment, information elements, such as those depicted in FIG. 7A and FIG. 7B, may be stored on a server, one or more mobile computing devices, and combinations thereof. The information elements may be used for various purposes to carry out aspects of some embodiments. For instance, some or all of the information elements may be used to determine whether a device was within the location and time bounds of a message as described above.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. At least one computing device configured to manage context-based messages, the at least one computing device comprising:
at least one wireless interface module;
at least one processor operatively coupled to the at least one wireless interface module; and
at least one non-transitory computer-readable storage medium operatively coupled to the at least one processor, the at least one non-transitory computer-readable storage medium comprising one or more programming instructions that, when executed, cause the at least one processor to:
receive device location information associated with each of a plurality of mobile computing devices,
accept a message received via the wireless interface module, the message comprising message location information and message time information, and
transmit the message to at least one of the plurality of mobile computing devices responsive to the device location information of the at least one of the plurality of mobile computing devices corresponding to the message location information and device time information of the at least one of the plurality of mobile computing devices corresponding to the message time information.

2. The at least one computing device of claim 1, wherein the one or more programming instructions, when executed, further cause the processor to deliver the message to at least one of the plurality of mobile computing devices based on a past location of the at least one of the plurality of mobile computing devices, wherein the message is delivered responsive to the at least one of the plurality of mobile computing devices being associated with the message location information at a time specified by a past time.

3. The at least one computing device of claim 1, further comprising delivering the message to at least one of the plurality of mobile computing devices based on a future location of the at least one of the plurality of mobile computing devices, wherein the message is delivered responsive to the at least one of the plurality of mobile computing devices being associated with the message location information at a time specified by a future time.

4. The at least one computing device of claim 1, wherein the at least one non-transitory computer-readable storage medium is operative to store the device location information as historical device location data and the device time information as historical device time data.

5. The at least one computing device of claim 1, wherein the one or more programming instructions, when executed, further cause the processor to:
periodically check for a location change for each of the plurality of mobile computing devices;
check for a current message associated with device location information corresponding to the location change; and
send an alert, responsive to locating the current message, to each of the plurality of mobile computing devices that have a location change corresponding with the device location information, the alert being configured to communicate that the current message is available for delivery.

6. The at least one computing device of claim 1, wherein the one or more programming instructions, when executed, further cause the processor to:
receive demographic information associated with the plurality of mobile computing devices; and
transmit the message to at least one of the plurality of mobile computing devices based on the message location information, the message time information, and the demographic information.

7. The at least one computing device of claim 1, wherein the demographic information comprises one or more of the following: age, gender, interests, consumer preferences, educational background, and address information.

8. The at least one computing device of claim 1, wherein the one or more programming instructions, when executed, further cause the processor to:
determine a device area for each of the plurality of mobile computing devices defined by a device geographic location and a device location area; and
determine a message area for the message defined by a message geographic location and a message radius,
wherein the device location information corresponds to the message location information responsive to the device area intersecting the message area.

9. A computer-implemented method for managing context-based messages, the method comprising:
receiving, at a computing device, device location information for each of a plurality of mobile computing devices;
accepting, at the computing device, a message for at least one of the plurality of mobile computing devices, the message comprising message location information and message time information; and
transmitting, via the computing device, the message to at least one of the plurality of mobile computing devices responsive to the device location information of the at least one of the plurality of mobile computing devices corresponding to the message location information and device time information of the at least one of the plurality of mobile computing devices corresponding to the message time information.

10. The computer-implemented method of claim 9, further comprising delivering the message to at least one of the plurality of mobile computing devices based on a past location of the at least one of the plurality of mobile computing devices, wherein the message is delivered responsive to the at least one of the plurality of mobile computing devices being associated with the message location information at a time specified by a past time.

11. The computer-implemented method of claim 9, further comprising delivering the message to at least one of the plurality of mobile computing devices based on a future location of the at least one of the plurality of mobile computing devices, wherein the message is delivered responsive to the at least one of the plurality of mobile computing devices being associated with the message location information at a time specified by a future time.

12. The computer-implemented method of claim 9, further comprising determining a device area for each of the plurality of mobile computing devices defined by a device geographic location and a device location area.

13. The computer-implemented method of claim 12, further comprising determining a message area for the message defined by a message geographic location and a message radius.

14. The computer-implemented method of claim 13, wherein the device location information corresponds to the message location information responsive to the device area intersecting the message area.

15. A computer-readable storage medium comprising instructions that, when executed, cause a system to:
receive device location information for each of a plurality of mobile computing devices;
accept a message for at least one of the plurality of mobile computing devices, the message comprising message location information and message time information; and
transmit the message to at least one of the plurality of mobile computing devices responsive to the device location information of at least one of the plurality of mobile computing devices corresponding to the message location information and device time information of the at least one of the plurality of mobile computing devices corresponding to the message time information.

16. The computer-readable storage medium of claim 15, further comprising instructions that, when executed, cause the system to deliver the message to at least one of the plurality of mobile computing devices based on a past location of the at least one of the plurality of mobile computing devices, wherein the message is delivered responsive to the at least one of the plurality of mobile computing devices being associated with the message location information at a time specified by a past time.

17. The computer-readable storage medium of claim 15, further comprising instructions that, when executed, cause the system to deliver the message to at least one of the plurality of mobile computing devices based on a future location of the at least one of the plurality of mobile computing devices, wherein the message is delivered responsive to the at least one of the plurality of mobile computing devices being associated with the message location information at a time specified by a future time.

18. The computer-readable storage medium of claim 15, further comprising instructions that, when executed, cause the system to determine a device area for each of the plurality of mobile computing devices defined by a device geographic location and a device location area.

19. The computer-readable storage medium of claim 18, further comprising instructions that, when executed, cause the system to determine a message area for the message defined by a message geographic location and a message radius.

20. The computer-readable storage medium of claim 19, wherein the device location information corresponds to the message location information responsive to the device area intersecting the message area.
